(19) United States
(12) Patent Application Publication
(10) Pub. No.: US 2009/0150987 A1
(43) Pub. Date: Jun. 11, 2009

(54) SYSTEM AND METHOD FOR CONFIGURING ENVRIONMENTS OF PRIVATE SYSTEM USING SMART CARD IN PUBLIC SYSTEM

(75) Inventors: Jiyoung Kwak, Daejeon (KR); Dohyung Kim, Daejeon (KR); Wontae Kim, Daejeon (KR); Hwangu Lee, Daejeon (KR); Kyounghee Lee, Daejeon (KR)

Correspondence Address: AMPACC LAW GROUP, 13024 Beverly Park Road, Suite 205, Mukilteo, WA, 98275, US

(73) Assignee: Electronics Telecommunications Research Institute, Daejeon (KR)

(21) Appl. No.: 12/258,401

(22) Filed: Oct. 25, 2008

(30) Foreign Application Priority Data
Dec. 10, 2007 (KR) 10-2007-0127702

(51) Int. Cl. H04L 9/32

(52) U.S. Cl. 726/9

(57) ABSTRACT

Provided is a system and method for configuring environments of a private system using a smart card in a public system. The system includes a smart card that stores owner identification information, system-environment and work-environment information, private data, and payment information; a public system that authenticates a user of the smart card by using the owner identification information of the smart card and reconfigures a system and work environment similar to the private system to perform work continuously ; a service providing sever that provides an installation program or substitute program required for configuring the latest work environment of the user; and a payment server that pay a usage charge for the public system connected to the smart card.

### RELATED APPLICATIONS

The present application claims priority to Korean Patent Application Serial Number 10-2007-0127702, filed on Dec. 10, 2007, the entirety of which is hereby incorporated by reference.

### BACKGROUND OF THE INVENTION

1. Field of the Invention

The present invention relates to a system and method for configuring environments of a private system using a smart card, and in particular, to a system and method for configuring environments of a private system using a smart card in a public system, which can provides work environment similar to a private system without time or place restrictions by connecting a smart card, which stores owner identification information, user system-environment and work-environment configuration information, private data, and payment data, to a public system such as a computer, a notebook computer, a PDA, an embedded system.

This work was supported by the IT R&D program of MIC/IITA [2006-S-038-02, Development of Device-Adaptive Embedded Operating System for Mobile Convergence Computing].

2. Description of the Related Art

Due to the common distribution of computers, the Internet is commonly used on a daily aspect. Accordingly, when a user cannot use his/her own system, the user needs to use a public system provided in a public place such as an Internet café, a school, a hotel, or another person's system. In this case, the user may reconstruct the environment of a public computer, which is to be used by the user, in accordance to the user's preference. Alternately, the user may carry a portable device such as a USB memory card, which stores files processed in the user's computer. However, in this case, if the user has never used the OS (Operating System) of the public system or a program associated with a file to be processed is not installed in the public system, a required job cannot be performed because a work environment that the user wishes is not provided.

With the accessibility to the various networks, the use of public systems will be popularized in order to satisfy demands of various services without time and place restrictions. Further, the environment of the public system needs to be reconfigured to become a user friendly work environment, or processes under working needs to be continued.

Now, the related techniques will be described.

Outdoor computers are systems that can search and utilize various information or data via the Internet without time and place restrictions by inserting a coin or using a coupon or a ticket like a telephone card.

Specifically, with the rapid development of the mobile phone market, telephone booths which are installed and operated by the telecommunication company are no longer commonly used. But, if the telephone booths are remodeled so as to have computers which can be operated by coins or prepaid cards like a public telephone, the telephone booths can provide convenient services.

The outdoor computer includes a main computer system which connects the separate telephone booths and a sub-computer system, a monitor, a keyboard, and a mouse of each of the telephone booths. Further, the outdoor computer may include equipment that is capable of receiving a usage fee, a coin slot, a prepaid card slot, and so on. Furthermore, the outdoor computer may include a printer, a speaker, and various convenient equipments.

With a prepaid telephone card, people can also use the outdoor computer in telephone booths where a public telephone is installed at the same cost as the telephone. Further, the outdoor computer can provide various services to search various information and data or play Korean checkers or chess, and games through the Internet.

In addition, a desktop box has both a telephone function and a PC function, and the size of the desktop box is as small as a telephone. Therefore, when a telephone function and a PC function are integrated, a space occupied by a telephone and a PC can be minimized. Further, since a telephone line and an Internet connection line are integrated, the wiring lines of an office can be simplified and it can provide both telephone function and the PC function.

The desktop box having a telephone function and a PC function integrated therein includes a handset that receives/transmits to the user/receiver; an IO (Input/Output) module that inputs and outputs information to and from a PC peripheral device and receives an input from the user and displays the result of the input; a memory including one chip embedded with Linux in which a VOIP (Voice Over Internet Protocol) client for implementing a telephone function using the handset and an RDP (Remote Desktop Protocol) client for implementing a PC function using the IO module are mounted; a control module that controls to input and output the information between the handset and the IO module and transmit and receive the information through a network corresponding to the VOIP and RDP clients stored in the memory; a network module that transmits and receives information for using a telephone or public PC through the network in accordance with the control of the control module; and a numeric keypad that is used for the user to input the telephone number of a receiver into the VIOP client stored in the memory.

The desktop box can implement the telephone function and the PC function by using a phone sized small box, which can minimize a space occupied by a telephone and a PC. Accordingly, a telephone line and an Internet connection line are integrated, resulting in simplifying the wiring lines of an office. As a result, as a smaller number of PCs are used by a large number of users, thereby reducing a cost for upgrading PCs and a cost for purchasing individual programs.

### SUMMARY OF THE INVENTION

An advantage of the present invention is that it provides a system and method for configuring environments of a private system using a smart card in a public system, which authenticates a user connected to a public system through an authentication program that uses owner identification information of a smart card or a certificate, and reconfigures the environment of the public system on the basis of system-environment and work-environment configuration information stored in the smart card so as to provide a work environment similar to that of a private system such that the user can continuously perform work without time or place restrictions.

Further, another advantage of the present invention is to prevent information leakage, which may occur in a public system that is shared by everyone, by storing contents processed in the public system and personal data in the portable smart card, and recovering the original status of the public system from the reconfigured environment when the work performed in the public system is completed.

According to an aspect of the invention, a public system using a smart card includes a user authentication module that authenticates a user of the smart card connected to the public system; a system-environment and work-environment configuration module that is connected to a service providing server and receives an installation program or a substitute program to reconfigure the latest work environment of the user, on the basis of system-environment and work-environment configuration information recorded in the smart card; and a system-environment and work-environment configuration information recording module that records the latest system-environment and work-environment configuration information of the public system into the smart card.

The public system further includes a usage charge payment module that is connected to a payment server, pay a system usage charge, and records details of usage and payment settlement.

When the service providing server cannot provide the installation program, the system-environment and work-environment configuration module may receive the substitute program for the installation program.

When the user's work is completed, the system-environment and work-environment configuration module may recover the original status from the work environment of the public system.

The usage charge payment module may demand a usage charge by using payment information provided from the smart card and may output the payment settlement and details of the system usage on a screen.

The public system may be any one of a general computer system used in offices, schools, or homes, a mobile device system such as a mobile phone, a notebook computer, or a PDA (Private Digital Assistant), and a commonly used embedded system.

According to an another aspect of the invention, a smart card which is connected to a public system so as to be used in the public system, includes an owner identification information storing unit that stores owner identification information for authenticating a user of the smart card; a system-environment and work-environment configuration information storing unit that stores the latest system-environment and work-environment configuration information; and a private data storing unit that stores private data.

The smart card further includes a payment information storing unit that stores a payment information for paying a usage charge for the public system.

The system-environment information may include a system type, OS (Operating System) information, and installation program information.

The work-environment information may include the status of processes which had been performed and process screen configuration information.

According to a further aspect of the invention, a method for configuring environments of a private system using a smart card in a public system comprises: authenticating a user of the smart card on the basis of the owner identification information of the smart card, and determining whether the user has authority or not; reconfiguring the environment of the public system on the basis of the system-environment and work-environment configuration information of the smart card if it is determined that the user has authority; determining whether an installation program required to reconfigure the system environment is present or not, and requesting the installation program required for reconfiguring the system environment or a substitute program for the installation program from a service providing server, thereby receiving the program; and reconstructing the latest work status on the basis of the work-environment configuration information;

The method further comprises storing private data that is created or corrected in the reconfigured work environment of the public system, into a private data storing unit of the smart card; and storing a current work status into a system-environment and work-environment storing unit of the smart card when the user completes the work or intends to remove the smart card from the public system.

The authenticating of the user may include: when the user of the smart card is not authenticated, displaying that the user does not have authority, transmitting a robbery alarm message to a mobile terminal of the card owner when the authentication fails, and stopping the operation of the smart card.

The method further includes: paying a system usage charge by using payment information of the smart card, and recovering the original system environment.

### BRIEF DESCRIPTION OF THE DRAWINGS

FIG. 1 is a conceptual view of a service scenario for configuring a work environment similar to a private system in a public system according to an embodiment of the present invention.

FIG. 2 is a diagram showing the configuration of a system for providing a work environment similar to a private system using a smart card in a public system according to the embodiment.

FIG. 3 is a flow chart for explaining a method for configuring a work environment similar to a private system in a public system according to the embodiment.

### DETAILED DESCRIPTION OF THE INVENTION

Hereinafter, preferred embodiments of the present invention will be described in detail with reference to the accompanying drawings.

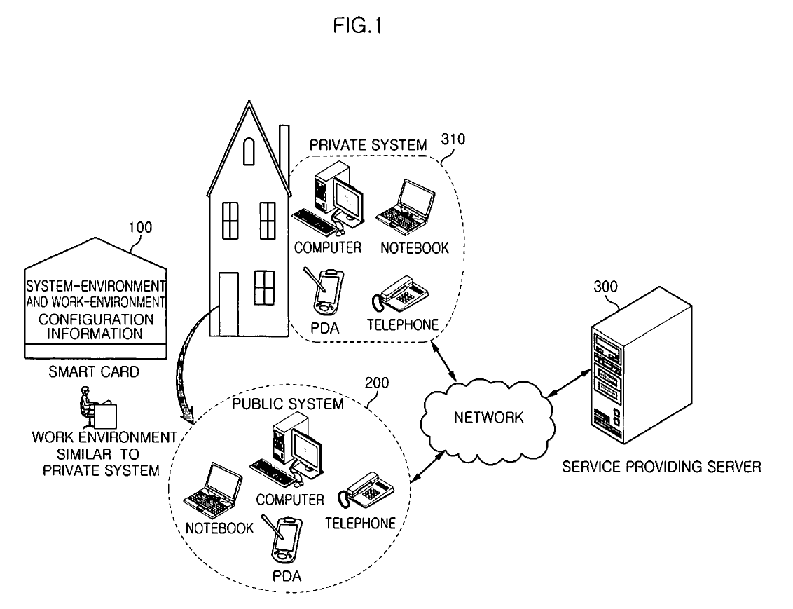

FIG. 1 is a conceptual view of a service scenario for configuring a work environment similar to a private system in a public system according to an embodiment of the present invention.

In general, a smart card is referred to as an IC (Integrated Circuit) card serving as an electronic credit card which has an IC memory component mounted to store large-volume information. The smart card is used as a transportation card, a credit card or the like. Examples of the smart card include a memory-type smart card which has no microprocessor, a smart card which has a microprocessor and memory built therein, and an interactive smart card which has a microprocessor, a memory, an I/O protocol, and an application program built therein.

The smart card 100 according to an embodiment of the invention includes a microprocessor, a memory, an I/O interface, and an application program and stores data processed in a private system 310. A user can carry the smart card 100 that is inserted into the card slot of a public system 200 or is recognized by a card recognition device mounted in a public system. In this case, the smart card may be used in a wired or wireless communication scheme.

A user stores private data created in the private system 310 in the smart card 100 of the user, and carries the smart card 100. Then, if necessary, the user may insert the smart card 100 into an arbitrary public system 200, for example, a general computer system, a mobile device system, such as a notebook computer or a PDA (Personal Digital Assistant), or an embedded system such as a telephone that is commonly used. Alternately, the smart card 100 is recognized by a card recognition device of a public system. Then, the current system environment and work environment of the user can be re-configured in the public system 200 such that the user can conveniently use the private data.

The public system 200 includes a commonly used embedded system such as a telephone as well as a general computer used in offices, schools, and homes and a mobile device such as a mobile phone, a notebook, or a PDA.

For example, when a telephone is used as the public system 200, the telephone has a smart card slot or a smart card recognition device. A user who carries a smart card 100 storing private data such as a telephone call list may refer the telephone call list by inserting the smart card into a telephone of an arbitrary telephone booth or causing the smart card to be recognized by a card recognition device installed in the telephone to make a call.

The service providing server 300 receives request information on system environment and work environment from the public system 200 into which the smart card 100 is inserted or by which the smart card 100 is recognized. Then, the service providing server 300 transmits a required installation program to the public system 200 through the network. When it is difficult to provide an installation program (for example, MS Word) required for the configuration of work environment, the service providing server 300 transmits a substitute program (MS Word viewer) to the public system 200.

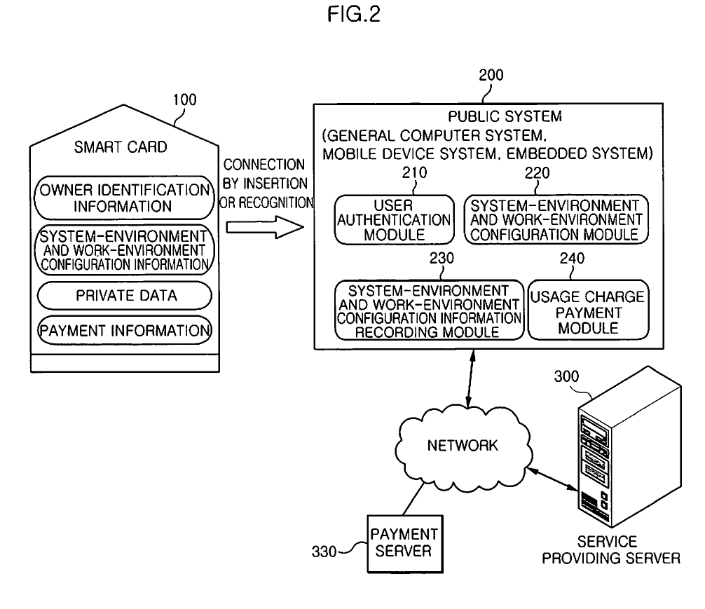

FIG. 2 is a diagram showing the configuration of a system for providing a work environment similar to a private system using a smart card in a public system according to the embodiment.

The system for providing a work environment similar to a private system using a smart card in a public system includes a smart card 100, a public system 200, a service providing server 300, and a payment server 330.

The smart card 100 is recognized by inserting into a smart card slot of the public system 200, or recognized by a card recognition device of the public system 200, and is connected to the public system 200 through wired or wireless communication. The smart card 100 includes an owner identification information storing unit which stores owner identification information for authenticating a user of the smart card; a system-environment and work-environment configuration information storing unit which stores the latest system-environment and work-environment configuration information; and a private data storing unit which stores private data processed in the private system 310, if necessary; and a payment information storing unit which stores the payment information for paying usage charge for the public system 200.

The system-environment and work-environment configuration information of the smart card 100 includes system-environment information such as a system type, an OS (Operating System) type, and basic installation programs, and work-environment information such as the statuses of processes which had been performed, process screen configuration information.

The public system 200 includes a user authentication module 210, a system-environment and work-environment configuration module 220, a system-environment and work-environment configuration information recording module 230, and a usage charge payment module 240.

The user authentication module 210 performs user authentication of the public system 200 by using the owner identification information of the smart card 100.

The system-environment and work-environment configuration module 220 is connected to the service providing server 300 and receives a necessary installation program or substitute program to configure the latest work environment, based on the system-environment and work-environment configuration information of the smart card 100.

The system-environment and work-environment configuration module 220 requests installation programs that are required for providing a work environment similar to the private system 310 of the user, through the network from the service providing server 300. When it is difficult for the service providing server 300 to provide an installation program the system-environment and work-environment configuration module 220 downloads a substitute program to configure a work environment as similar to the private system as possible, and then notifies the status information to the user.

The system-environment and work-environment configuration information recording module 230 records current work-status information into the smart card 100 after the work in the public system 200 is completed.

The usage charge payment module 240 requests information on usage charge for the public system 200 from the payment server 330 and pays the usage charge by using the payment information of the smart card 100 such as credit card information or bank account information. Then, the usage charge payment module 240 records the details of usage and payment settlement and displays the details and settlement on a screen through a display unit.

The service providing server 300 is connected to the system-environment and work-environment configuration module 220 of the public system 200. When the public system 200 is reconfigured with the latest work environment of a user in accordance with a request of the user, the service providing server 300 transmits an installation program requested by the user or a substitute program to the system-environment and work-environment configuration module 220 through the network.

The payment server 330 is connected to the usage charge payment module 240 of the public system 200 and provides a payment function for service charge of the public system using the smart card.

For example, if a user needs to stop due to an unexpected event during a job of creating a MS Word document by using the user's computer, the user stops the job and stores private data created by MS Word into the smart card 100 to complete the MS Word document somewhere other than the user's personal computer. In this case, the user may continue the word-processing work in an arbitrary public system 200 of an Internet café by using the smart card 100.

When the user inserts the smart card 100 into the public system 200 or allows the smart card 100 to be recognized by a card recognition device, card authentication is carried out, and the system-environment and work-environment information recorded in the smart card 100 is used to re-configure an environment similar to the private system 310 of the user.

When an environment similar to the private system 310 is configured, the public system 200 configures a system environment based on system environment information including a system type, an OS type, required installation programs and so on. However, when it is difficult to configure the same environment as the private system, a similar substitute environment is configured to provide a system environment familiar with the user.

Further, the installation program (MS Word) or substitute program (MS Word Viewer) required for configuring an environment similar to the private system 310 is downloaded from the service providing server 300 by requesting the program on the basis of the system environment information of the smart card 100.

Furthermore, the public system 200 configures a work environment similar to the latest work environment of the user's computer by using the work-environment information of the smart card 100 including the statuses of processes which have been performed and process screen configuration information.

For example, a user needs to stop a job due to some reasons during the job of creating a MS Word document and a picture which is to be inserted into the document. In this case, when the user resumes the job in an Internet café by using the smart card, the screen arrangement and status of recently-stored processes are reconstructed. Therefore, the user can perform the word processing work and the picture editing work, as if the user performs the works in the user's computer.

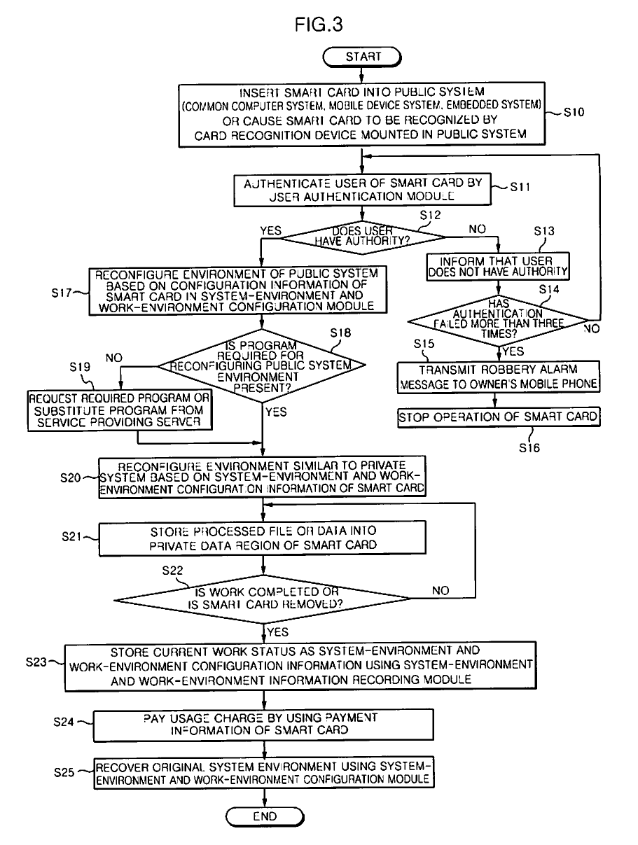

FIG. 3 is a flow chart for explaining a method for configuring a work environment similar to a private system in a public system according to an embodiment of the present invention.

Referring to FIG. 3, if a user has a work to be performed, the user insert a smart card 100 carried by the user into an arbitrary public system 200 close to the current position of the user or allows the smart card to be recognized by a card recognition device mounted on the public system 200 (step S10). Then, a user authentication module 210 of the public system 200 authenticates the user of the smart card 100 on the basis of owner identification information stored in the smart card 100 (step S11), and determines whether the user has authority or not (step S12).

If the user is not authenticated, the public system 200 displays that the user does not have authority (step S13). If the authentication fails more than three times (step S14), the public system 200 transmits a robbery warning message to the owner's mobile phone to inform such a status (step S15), and then stops the operation of the smart card 100 (step S16).

If it is determined that the user has authority, a system-environment and work-environment configuration module 220 of the public system 200 reconfigures the environment of the public system on the basis of the system-environment and work-environment information of the smart card 100 (step S17).

The system-environment and work-environment configuration module 220 of the public system 200 determines whether an installation program required for reconfiguring a system environment is present or not (step S18). When the installation program is not present, the system-environment and work-environment configuration module 220 requests the installation program or a substitute program from the service providing server 300 connected through the network, thereby receiving the program (step S19).

The public system 200 configures a system environment similar to a private system by using the system-environment and work-environment configuration information of the smart card 100. Further, the public system 200 reconfigures the work environment of the smart card 100 such that the latest operation processes can be continuously performed as they are (step S20).

The public system 200 stores private data, which is created or corrected in the reconfigured work environment, into a private data storing unit of the smart card 100 (step S21).

When the user completes the work or removes the smart card 100 from the public system 200 (step S22), a system-environment and work-environment configuration information recording module 230 of the public system 200 records a current work status into the system-environment and work-environment configuration information storing unit of the smart card 100 (step S23). Then, the usage charge payment module 240 demands payment of a system usage charge by using the payment information of the smart card 100 so that the payment is achieved (step S24), and the system-environment and work-environment configuration module 220 recovers the original system environment (step S25).

After the user uses the public system, the public system 200 stores work contents and private data into the smart card 100 carried by the user. When the work which was being performed in the public system 200 is completed, the public system 200 recovers the original status from the reconfigured work environment.

In this way, the user can prevent information leakage which may occur in the public system 200 which is shared by everyone.

Further, the owner of the smart card 100 that is carried by a user is confirmed through the user authentication process. Therefore, although the smart card 100 is lost or stolen, the owner does not need to worry about it.

According to the present invention, the smart card is inserted into a public system to reconfigure a work environment similar to a private system such that private data can be utilized as if a user carries the private system. Further, since the continuity of work is provided regardless of a used system, it is possible to increase work efficiency.

Further, when a private system is out of order, the system can be easily reconstructed using the smart card. Further, since the information of the smart card is provided through the user authentication process in the public system, it is possible to prevent information leakage.

While the present invention has been described with reference to exemplary embodiments thereof, it will be understood by those skilled in the art that various changes and modifications in form and detail may be made therein without departing from the scope of the present invention as defined by the following claims.

What is claimed is:

1. A public system using a smart card, comprising:
a user authentication module that authenticates a user of the smart card connected to the public system;
a system-environment and work-environment configuration module that is connected to a service providing server and receives an installation program or a substitute program to reconfigure the latest work environment of the user, on the basis of system-environment and work-environment configuration information recorded in the smart card; and
a system-environment and work-environment configuration information recording module that records the latest system-environment and work-environment configuration information of the public system into the smart card.

2. The public system according to claim 1 further comprising:
a usage charge payment module that is connected to a payment server, pays a system usage charge, and records usage information and payment information.

3. The public system according to claim 1,
wherein when the service providing server cannot provide the installation program, the system-environment and work-environment configuration module receives the substitute program for the installation program.

4. The public system according to claim 1,
wherein when the user's work is completed, the system-environment and work-environment configuration module recovers the original status from the work environment of the public system.

5. The public system according to claim 2,
wherein the usage charge payment module pays a usage charge by using payment information provided from the smart card and outputs the payment settlement and details of system usage on a screen.

6. The public system according to claim 1,
wherein the public system is any one of a general computer system used in offices, schools, or homes, a mobile device system, and a commonly used embedded system.

7. A smart card which is connected to a public system so as to be used in the public system, comprising:
an owner identification information storing unit that stores owner identification information for authenticating a user of the smart card;
a system-environment and work-environment configuration information storing unit that stores the latest system-environment and work-environment configuration information; and
a private data storing unit that stores private data.

8. The smart card according to claim 7, further comprising:
a payment information storing unit that stores a payment information for paying a usage charge for the public system.

9. The smart card according to claim 7,
wherein the system-environment information includes a system type, OS (Operating System) information, and installation program information.

10. The smart card according to claim 7,
wherein the work-environment information includes the status of processes which have been performed and process screen configuration information.

11. A method of configuring environments of a private system using a smart card in a public system, the method comprising:
authenticating a user of the smart card on the basis of the owner identification information of the smart card, and determining whether the user has authority or not;
reconfiguring the environment of the public system on the basis of the system-environment and work-environment configuration information of the smart card if it is determined that the user has authority;
determining whether an installation program required for reconfiguring the system environment is present or not, and requesting the installation program required for reconfiguring the system environment or a substitute program for the installation program from a service providing server, thereby receiving the program; and
reconstructing the system environment similar to the private system by using the system-environment configuration information and reconstructing the latest work status on the basis of the work-environment configuration information.

12. The method according to claim 11, further comprising:
storing private data that is created or corrected in the reconfigured work environment of the public system, into a private data storing unit of the smart card; and
storing a current work status into a system-environment and work-environment storing unit of the smart card when the user completes the work or intend to remove the smart card from the public system.

13. The method according to claim 11,
wherein the authenticating of the user includes:
when the user of the smart card is not authenticated, displaying that the user does not have authority, transmitting a robbery alarm message to a mobile terminal of the card owner when the authentication fails and stopping the operation of the smart card.

14. The method according to claim 11, further comprising:
paying a system usage charge by using payment information of the smart card

15. The method according to claim 11, further comprising:
recovering the original system environment of the public system by a system-environment and work-environment configuration module.
